(19) United States
(12) Patent Application Publication
(10) Pub. No.: US 2013/0152780 A1
(43) Pub. Date: Jun. 20, 2013

(54) Installation Assembly with Sealing Apparatus

(71) Applicant: Endress + Hauser Wetzer GmbH + Co. KG, Nesselwang (DE)

(72) Inventors: Massimo Del Bianco, Monza (IT); Massimo Trafi, Varzi (IT); Detlef Schuttenberg, Kaufbeuren (DE); Shakil Ahmed, Pioltello (IT)

(73) Assignee: Endress + Hauser Wetzer GmbH + Co. KG, Nesselwang (DE)

(21) Appl. No.: 13/713,027

(22) Filed: Dec. 13, 2012

Related U.S. Application Data
(60) Provisional application No. 61/570,932, filed on Dec. 15, 2011.

(30) Foreign Application Priority Data
Dec. 15, 2011 (DE) 102011088736.9

(51) Int. Cl. F16J 15/00

(52) U.S. Cl. CPC F16J 15/00
USPC 92/165 R

(57) ABSTRACT

A sealing apparatus for an installation assembly, which installation assembly serves for accommodating a measuring insert, wherein the sealing apparatus includes a piston, a bushing and at least one sealing element. The piston and the bushing serve to accommodate the measuring insert by a bore provided in the piston and in the bushing, wherein the piston is additionally connected interactively with the bushing in such a manner that a pressure transmitted by the piston to the bushing serves to deform the sealing element, which is preferably arranged on at least one end of the bushing, and thereby to achieve a sealing action, in order, in the case of introduced measuring insert, to seal the bore, especially liquid or gas tightly.

### CROSS-REFERENCE TO RELATED APPLICATION

This application is Nonprovisional which claims the benefit of U.S. Provisional Application 61/570,932, filed on Dec. 15, 2011.

### TECHNICAL FIELD

The invention relates to an installation assembly with sealing apparatus, a sealing apparatus for an installation assembly and a kit for manufacturing a sealing apparatus.

### BACKGROUND DISCUSSION

In many hazardous material—and high power applications, it is necessary to use installation assemblies, in order to observe and/or to monitor conditions in a process. In such case, it is important that all necessary safety precautions, especially as regards sealing from the process environment, be taken into consideration.

Known from the state of the art in Offenlegungsschrift EP 2343514 A1 is an installation assembly for a rod-shaped measuring insert, wherein, for accommodating a measuring insert, a first safety chamber is provided in a first housing part and a second safety chamber in a second housing part, wherein the first housing part has a process connection and wherein the first housing part is connected to the second housing part on a side of the first housing part lying opposite the side with the process connection, and wherein a sealing apparatus is provided, which serves, in the case of measuring insert introduced into the assembly housing, to seal, especially relative to pressure- and/or to liquid, the second safety chamber relative to the first safety chamber. The sealing apparatus proposed there is, however, in given cases, irreversible, due to the proposed application of a graphite bushing. Additionally, the sealing apparatus proposed there must be manually operated, in order to achieve the sealing action.

### SUMMARY OF THE INVENTION

An object of the invention is, thus, to provide a simpler and, above all, self-sealing apparatus.

This object is achieved by a kit, a sealing apparatus and an installation assembly.

As regards the kit, the object is achieved by a kit for manufacturing a sealing apparatus for an installation assembly, which installation assembly serves for accommodating a measuring insert; wherein the kit includes a piston, a bushing, and at least one sealing element; and wherein the piston and the bushing are assemblable and serve to accommodate the measuring insert by a bore provided in the piston and the bushing, wherein the piston, when assembled with the bushing, is interactively connected with the bushing in such a manner that a pressure transmitted by the piston to the bushing serves to deform the sealing element (which is preferably arrangeable on at least one end of the bushing) and thereby to achieve a sealing action, in order, in the case of introduced measuring insert, to seal the bore extending through the piston and the bushing.

Existing installation assemblies can, with application of such a kit, be retrofitted with a sealing apparatus. In this regard, a sealing apparatus formed from the kit can be arranged, for example, between a process connection of a container, in which a medium is located, and a housing part of the installation assembly provided for connection with the process connection.

As regards the sealing apparatus, the object is achieved by a sealing apparatus for an installation assembly, which installation assembly serves for accommodating a measuring insert; wherein the sealing apparatus includes a piston, a bushing and at least one sealing element; and wherein the piston and the bushing serve to accommodate the measuring insert by a bore provided in the piston and in the bushing; wherein the piston is additionally connected interactively with the bushing in such a manner that a pressure transmitted by the piston to the bushing serves to deform the sealing element, which is preferably arranged on at least one end of the bushing, and thereby to achieve a sealing action, in order, in the case of introduced measuring insert, to seal the bore, especially liquid or gas tightly.

In a form of embodiment of the sealing apparatus, the sealing element is arranged, or arrangeable, coaxially around the measuring insert, and the sealing element is preferably an O-ring.

The sealing element is composed, in such case, preferably of an elastic material, so that the at least one measuring insert, in the case, in which the piston is not loaded with pressure, can be drawn through the bore and the sealing elements, in order, for example, to replace the at least one measuring insert.

As regards the installation assembly, the object is achieved by an installation assembly with a sealing apparatus according to one of the aforementioned forms of embodiment of the sealing apparatus, wherein the installation assembly has a first housing part, which is connectable to a process connection, and wherein, on the side of the first housing part facing the process connection, the sealing apparatus is insertable into a recess of the first housing part.

The proposed sealing apparatus can improve reliability and replacement of measuring transducers in a plant. Additionally, costs can be saved, since, for example, the duration of operation between inspections can be increased. The proposed sealing apparatus can additionally be applied as a retrofit to known sealing apparatuses, so that an additional sealing stage is obtained.

The sealing apparatus is additionally embodied in such a manner that it can be integrated into the process connection or into a flange, such as, for example, the first housing part, or between the first housing part and the process connection.

Additionally, the proposed invention can be applied, especially when a number of measuring inserts are present, in order, for example, to determine a temperature curve, or a temperature profile, in a container.

An idea of the invention is to provide an automatic sealing mechanism, which utilizes a pressure difference between medium present in the process and the environment of the process. As a result, the proposed invention is independent of secondary leakage indicators, since it responds to the leakage itself.

In a form of embodiment of the installation assembly, the recess in the first housing part has a floor, wherein on the floor of the recess likewise at least one bore is provided, which serves for accommodating the at least one measuring insert. Furthermore, an additional housing part of the installation assembly can be located on the first housing part and, indeed, on the side of the first housing part facing away from the process/process connection. This additional housing part can include, for example, a measuring- and/or operating electronics and/or connection terminals, via which the at least one measuring insert is electrically contactable. Furthermore, between the first housing part and the additional housing part, a safety chamber can be arranged, such as provided, for example, in EP 2343514 A1.

In an additional form of embodiment of the installation assembly the bore in the floor of the recess of the first housing part has a first section with a first diameter and a second section with a second diameter, wherein the first diameter is larger than the second diameter, wherein the first section of the bore adjoins the floor, and wherein the second section adjoins the first section.

In an additional form of embodiment of the installation assembly, the transition of the first section to the second section occurs via a shoulder facing the floor of the recess of the first housing part. For example, the sealing element can be located on this shoulder, for example, a sealing element in the form of an O-ring.

In an additional form of embodiment of the installation assembly, the bushing is introducible into the first section of the bore in the first housing part, wherein the shoulder serves as a stop for the bushing.

In an additional form of embodiment of the installation assembly, the sealing element is arranged between the stop and the bushing.

In an additional form of embodiment of the installation assembly, the bore in the piston has a first and a second section with a first and, respectively, a second diameter, wherein the first diameter is greater than the second diameter, and wherein the transition between the first section and the second section occurs by means of a shoulder, which serves as a stop for the bushing insertable into the first section

In an additional form of embodiment of the installation assembly, the sealing element is arranged between the stop and the bushing in the bore of the piston.

In an additional form of embodiment of the installation assembly, the installation assembly includes a second housing part, which adjoins the first housing part on the side of the first housing part facing away from the process connection, and the second housing part has an operating electronics and/or connections for connecting the at least one measuring insert to electrical connection lines.

In an additional form of embodiment of the installation assembly, the process connection has at least one bore, through which the at least one measuring insert is introducible, preferably in a protective tube.

In an additional form of embodiment of the installation assembly, the installation assembly, especially the sealing apparatus of the installation assembly, is so designed, preferably so matched to a running process and its pressure difference relative to an ambient pressure, that, in the case of leakage of the protective tube, a pressure present in the protective tube and the bore provides that the bushing is pressed via the piston against the at least one sealing element, in order to achieve the sealing action.

In an additional form of embodiment of the installation assembly, in the floor of the recess of the first housing part, in the piston and in the process connection, there are provided a plurality of essentially mutually parallel bores, each of which serves for accommodating a measuring insert, and wherein each of these bores has a sealing element and a bushing, which serve to seal the bore, especially in the case of leakage.

In an additional form of embodiment of the installation assembly, the bores are arranged, preferably equidistantly, on a circle coaxially to a longitudinal axis of the installation assembly.

In an additional form of embodiment of the installation assembly, the bores and/or the measuring inserts have different lengths.

In an additional form of embodiment of the installation assembly, there is arranged on an end of a measuring insert at least one measuring transducer, which serves for determining a chemical and/or physical variable, preferably temperature.

### BRIEF DESCRIPTION OF THE DRAWINGS

The invention will now be explained in greater detail based on the appended drawing, the figures of which show as follows:

FIG. 1 is a schematic representation of a longitudinal section through a sealing apparatus integrated into an installation assembly;

FIG. 2a) is a schematic representation of a first possible arrangement of bores for accommodating a plurality of measuring inserts;

FIG. 2b) is a schematic representation of a second possible arrangement of bores for accommodating a plurality of measuring inserts;

FIG. 3 is a exploded view of a sealing apparatus and a first housing part of an installation assembly;

FIG. 4a) is a longitudinal section through a sealing apparatus integrated into an installation assembly, in the starting position, i.e. without pressure loading; and

FIG. 4b) is a cross section through a sealing apparatus integrated into an installation assembly, in the compressed, i.e. pressure loaded, position.

### DETAILED DESCRIPTION IN CONJUNCTION WITH THE DRAWINGS

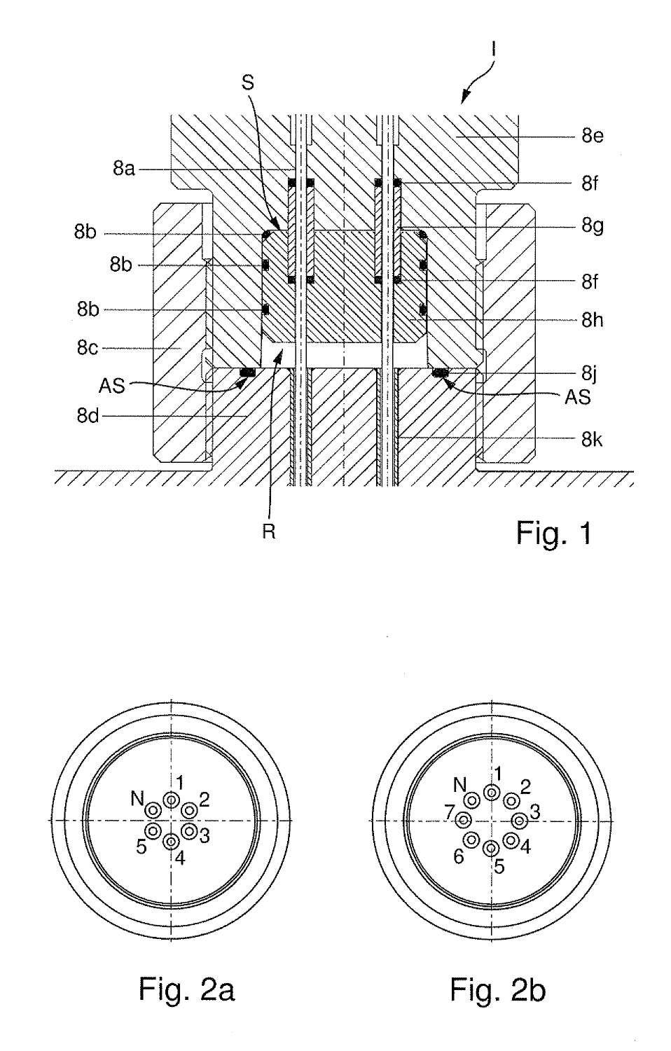

FIG. 1 shows a sealing apparatus S, which is integrated in an installation assembly I. The installation assembly I is secured to a process connection 8d, for example, a mount on a container, such as, for example, a tank or a pipe. In the example of an embodiment according to FIG. 1, the process connection 8d has, for this purpose, a screw thread, onto which a coupling nut 8c can be screwed. The coupling nut 8c serves additionally for receiving a first housing part 8e of the installation assembly I arranged on the side of the process connection 8d facing away from the process. This first housing part 8e can be connected to the coupling nut 8c and to the process connection 8d, for example likewise via the screw thread of the coupling nut 8c. To this end, the coupling nut 8c has an internal thread, which is connectable both to an external thread of the process connection 8d as well as also to an external thread of the first housing part 8e. In such case, the region of the first housing part 8e, via which the first housing part 8e is connectable with the process connection 8d, is embodied in such a manner that it is connectable fitting accurately against the process connection 8d, so that the transition between the process connection 8d and the first housing part 8e occurs essentially without any offset between the two components 8d, 8e, but, instead, that the two components 8d, 8e can be oriented accurately fit and preferably in alignment relative to one another.

The installation assembly I additionally includes bores 8k, which serve for accommodating measuring inserts 8a. These measuring inserts 8a serve, in such case, for registering a measured variable, such as, for example, temperature, and have an essentially elongated, rod shape. The measuring inserts 8a are led through the bores 8k through the first housing part 8e, the sealing apparatus S and the process connection 8d. The process connection 8d can transition, on the side of the installation assembly I facing the process, into a protective tube, not shown, which protrudes inwardly into the process and protects the measuring inserts 8a from the medium.

On the abutment surface AS between the first housing part 8e and the process connection 8d, a seal 8j, for example, an O-ring, can be placed in a recess in the process connection 8d. Additionally, the first housing part 8e has a recess R, which faces the process connection and serves for accommodating the sealing apparatus. Recess R is preferably basically a blind hole, in whose floor the bores 8k are located. In the installed state, the bores 8k extending through the process connection open into the recess R of the first housing part 8e.

The recess R of the first housing part 8e serves, in such case, for the essentially exactly fitting accommodation of a piston 8h. Piston 8h has, in turn, bores 1-N likewise serving for accommodating the measuring inserts 8a. Additionally, the bores through the first housing part 8e, the piston 8h and the process connection 8d are embodied in such a manner that the measuring inserts 8a are introducible, and, respectively, arranged, through them essentially parallel to one another and extending in straight lines.

Recess R in the first housing part 8e can, in such case, be preferably essentially cylindrical and serve for accommodating a likewise essentially cylindrical piston 8h. Along its lateral surface, the piston 8h can have one or a plurality of grooves G, which serve for accommodating sealing elements 8b, such as, for example, sealing rings. The top and bottom of the piston 8h can be chamfered at the edges. In the hollow space created between the piston 8h and the first housing part 8e by this chamfering, a sealing element 8b, preferably likewise in the form of an O-ring, can be arranged. Through these precautionary measures, the piston 8h is sealed against the recess R in the first housing part 8e. In spite of these measures, the piston 8h can still be movable in the recess R of the first housing part 8e and, indeed, in such a manner that the piston 8h can shift its position by moving in the recess R in the direction of the longitudinal axis L of the installation assembly I.

Additionally, the bore 8k, respectively 1-N, extending through the piston 8h has in a first section a first diameter, which is larger than a second diameter in a second section of the bore. This first section serves, in such case, for accommodating a bushing 8g, which resides, on the one hand, in the piston 8h and, on the other hand, in a first section of the bore in the first housing part 8e, wherein this first section of the bore in the first housing part has a first diameter, which is larger than a second diameter of the bore.

In such case, the first section of the bore transitions into the second section of the bore via a shoulder both in the piston 8h as well as also in the first housing part 8e. These shoulders serve as stops for the bushing 8g. When the bushing is in the bore, a sealing element 8f, preferably in the form of an O-ring, is arranged between the bushing and the stop between the first and the second section of the bore.

If, now, there is, for example, a leakage of the installation assembly I, or the protective tube or the process connection 8c, then there often arises, as well, also a pressure difference between the process and the process environment. This pressure moves the piston 8h in the direction of the longitudinal axis L of the installation assembly I. Because of the presence of the bushing 8g, the sealing element 8f is deformed, so that the bore, into which the measuring insert 8a, or the measuring inserts 8a, is/are brought, becomes sealed.

In this way, an automatically acting sealing apparatus S is created, which, in the case of leakage, seals the bores 8k, 1-N serving to accommodate the measuring inserts 8a.

FIGS. 2a) and 2b) show different options for arranging the bores 8k, respectively, in the installation assembly I and in the piston 8h. In order to obtain an optimal force transmission from the piston 8h to the sealing elements 8f, the bores 1-N are distributed equidistantly along a circular path. The center of the circular path forms, in such case, the longitudinal axis L of the installation assembly I. The more bores 1-N, or measuring inserts 8a, the installation assembly I has, naturally the larger is the circular path to be chosen. In such case, the number of bores/measuring inserts, which can be used in the case of a particular piston thus depends on the size, especially the diameter, of the piston 8h.

FIG. 3 shows an exploded view of the sealing apparatus S (which is assembled essentially from a kit, and, respectively, is composed of a set of components) and the first housing part 8e of the installation assembly I. The first housing part 8e is connectable to a process insert 8d. The kit is composed, in such case, of a first set of sealing rings 8f, a set of bushings 8g, a second set of sealing rings 8f, a piston 8h and a third set of sealing rings 8b. The first and the second sets of sealing rings 8f are, in such case, arranged, respectively, on the ends of the corresponding bushings 8g, while the third set of sealing rings 8b is placed around the lateral surface of the piston 8h. For this purpose, the piston can have corresponding grooves G, which serve to hold the sealing rings 8b.

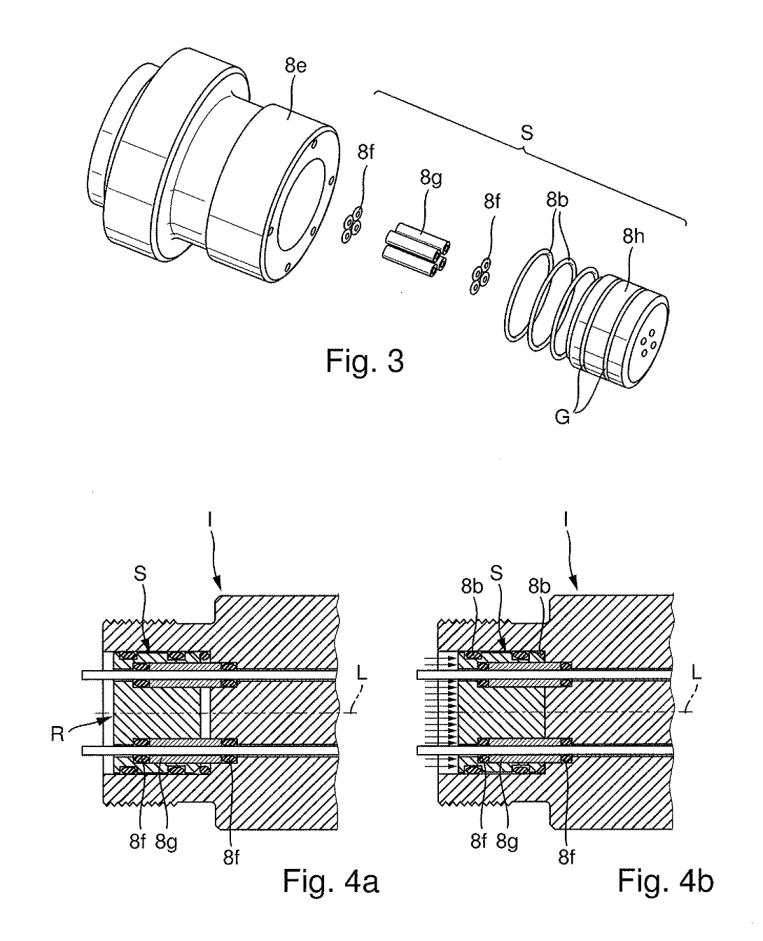

FIGS. 4a) and 4b) show again a longitudinal section through a installation assembly I. In such case, FIG. 4 a) shows the state, in which the sealing apparatus S is still in the starting position, while, in FIG. 4 b), the state is presented, in which the sealing apparatus S is located in the pressure loaded state. The pressure loading is indicated, in such case, by the arrows in FIG. 4 b) pointing toward the piston 8h.

In the position of the sealing apparatus S shown in FIG. 4 b), by the pressure, which the medium, or the process, exerts on the piston 8h, the seals 8f on the ends of the bushings 8g are deformed in such a manner that they exert a sealing action, and medium cannot escape through the bores 1-N, into which the measuring inserts 8a are inserted.

Likewise, the seal 8b placed between the chamfer (which bounds the top of the piston 8h) and the recess R in the first housing part 8e becomes deformed, so that the medium in the case of a leakage also cannot escape between the piston 8h and the wall of the recess R.

1. A kit for manufacturing a sealing apparatus for an installation assembly, which installation assembly serves for accommodating a measuring insert, the kit comprising:
a piston;
a bushing; and
at least one sealing element, wherein:
said piston and said bushing are assemblable and serve to accommodate the measuring insert by a bore provided in said piston and in said bushing; and
said piston, when assembled with said bushing, is interactively connected with said bushing in such a manner that a pressure transmitted by said piston to said bushing serves to deform said sealing element which is preferably arrangeable on at least one end of said bushing and thereby to achieve a sealing action, in order, in the case of introduced measuring insert, to seal said bore extending through said piston and said bushing.

2. The sealing apparatus for an installation assembly, which installation assembly serves for accommodating a measuring insert, the sealing apparatus comprises:
a piston;
a bushing; and
at least one sealing element, wherein:
said piston and said bushing serve to accommodate the measuring insert by a bore provided in said piston and in said bushing; and
said piston is additionally connected interactively with said bushing in such a manner that a pressure transmitted by said piston to said bushing serves to deform said sealing element, which is preferably arranged on at least one end of said bushing, and thereby to achieve a sealing action, in order, in the case of introduced said measuring insert, to seal said bore, especially liquid or gas tightly.

3. The sealing apparatus as claimed in claim 2, wherein:
said sealing element is arranged, or arrangeable, coaxially around said measuring insert; and
said sealing element is preferably an O-ring.

4. An installation assembly with a sealing apparatus comprising: a piston; a bushing; and at least one sealing element, wherein: said piston and said bushing are assemblable and serve to accommodate the measuring insert by a bore provided in said piston and in said bushing; and said piston, when assembled with said bushing, is interactively connected with said bushing in such a manner that a pressure transmitted by said piston to said bushing serves to deform said sealing element which is preferably arrangeable on at least one end of said bushing and thereby to achieve a sealing action, in order, in the case of introduced measuring insert, to seal said bore extending through said piston and said bushing,
wherein the installation assembly has:
a first housing part, which is connectable to a process connection; and
on the side of said first housing part facing said process connection, the sealing apparatus is insertable into a recess of said first housing part.

5. The installation assembly as claimed in claim 4, wherein:
said recess in said first housing part has a floor; and
on said floor of said recess likewise at least one bore is provided, which serves for accommodating said at least one measuring insert.

6. The installation assembly as claimed in claim 4, wherein:
said at least one bore in the floor of said recess of said first housing part has a first section with a first diameter and a second section with a second diameter; and
said first diameter is larger than said second diameter, and
said first section of said at least one bore adjoins the floor, and said second section adjoins said first section.

7. The installation assembly as claimed in claim 6, wherein:
the transition from said first section to said second section occurs via a shoulder facing the floor of said recess of said first housing part.

8. The installation assembly as claimed in claim 7, wherein:
said bushing is introducible into said first section of said at least one bore in said first housing part and said shoulder serves as a stop for said bushing.

9. The installation assembly as claimed in claim 8, wherein:
said sealing element is arranged between said stop and said bushing.

10. The installation assembly as claimed in claim 4, wherein:
said bore in said piston has a first and a second section with a first, and, respectively, a second diameter;
said first diameter is greater than said second diameter; and
the transition between said first section and said second section occurs by a shoulder, which serves as a stop for said bushing insertable in said first section.

11. The installation assembly as claimed in claim 10, wherein:
said sealing element is arranged between said stop and said bushing in said bore of said piston.

12. The installation assembly as claimed in claim 4, wherein:
a second housing part, which adjoins said first housing part on the side of said first housing part facing away from the process connection, and said second housing part has operating electronics and/or connections for connecting said at least one measuring insert to electrical connection lines.

13. The installation assembly as claimed in claim 4, wherein:
said process connection has at least one bore, through which said at least one measuring insert is introducible, preferably in a protective tube.

14. The installation assembly as claimed in claim 13, wherein:
the sealing apparatus of the installation assembly, is so designed, preferably is so matched to a running process and its pressure difference relative to an ambient pressure that, in the case of leakage of said protective tube, a pressure present in said protective tube and said at least one bore provides that said bushing is pressed via said piston against said at least one sealing element, in order to achieve the sealing action.

15. The installation assembly as claimed in claim 4, wherein:
in said floor of said recess of said first housing part, in said piston and in said process connection, there are provided a plurality of essentially mutually parallel bores, each of which serves for accommodating a measuring insert; and
each of these bores has a sealing element and a bushing, which serve to seal said bores, especially in the case of leakage.

16. The installation assembly as claimed in claim 15, wherein:
said bores are arranged, preferably equidistantly, on a circle coaxially to a longitudinal axis of the installation assembly.

17. The installation assembly as claimed in claim 15, or wherein:
said bores and/or said measuring inserts have differing lengths.

18. The installation assembly as claimed in claim 1, wherein:
there is arranged on an end of a measuring insert at least one measuring transducer, which serves for ascertaining a chemical and/or physical variable, preferably temperature.
